(19) United States
(12) Patent Application Publication
(10) Pub. No.: US 2011/0319261 A1
(43) Pub. Date: Dec. 29, 2011

(54) FOAM ELEMENT WITH CELLULOSE INCORPORATED IN IT

(75) Inventors: Josef Innerlohinger, Berg i. A. (AT); Manfred Marchgraber, Kremsmuenster (AT); Franz Schaufler, Kremsmuenster (AT); Friedrich Suchomel, Schoerfling (AT)

(73) Assignee: Eurofoam GmbH, Kremsmuenster (AT)

(21) Appl. No.: 13/138,230

(22) PCT Filed: Jan. 21, 2010
(86) PCT No.: PCT/AT2010/000022

§ 371 Date: Sep. 9, 2011

Related U.S. Application Data
(60) Provisional application No. 61/253,945, filed on Oct. 22, 2009.

(30) Foreign Application Priority Data
Jan. 22, 2009 (AT) A 100/2009

(51) Int. Cl. B01J 20/24; B01J 20/26; B01J 20/28

(52) U.S. Cl. 502/402; 502/404

(57) ABSTRACT

The invention relates to a foam element with a hydrophilic substance incorporated in the foam in the form of cellulose of the structure type based on the crystal modification of cellulose-II, and the foam element incorporating the cellulose has a reversible capacity to absorb moisture. A proportion of the cellulose is between 0.1% by weight and 10% by weight. A value of the foam moisture corresponding to an equilibrium moisture in a first ambient atmosphere is increased during use in a second ambient atmosphere. The moisture absorbed by the cellulose II after use evaporates again within a period of between 1 hour and 16 hours until the initial value of the foam moisture corresponding to the equilibrium moisture by reference to the ambient first atmosphere is restored.

The invention relates to a foam element with a hydrophilic agent in the form of cellulose incorporated in the foam, and the foam element displaced with the cellulose has a reversible capacity to absorb moisture, as described in claims 1 to 3.

These days, foams are used or employed in many areas of daily life. In many of these applications, the foams are in contact with the body, usually separated by only one or more textile intermediate layers. Most of these foams are made from synthetic polymers such as polyurethane (PU), polystyrene (PS), synthetic rubber, etc., which in principle do not have an adequate water absorption capacity. Particularly during longer periods of contact with the body or when undertaking strenuous exercise, an unpleasant physical climate develops due to the large amount of moisture that is not absorbed. For most applications, therefore, it is necessary for hydrophilic properties to be imparted to such foams.

This can be achieved in a number of ways. One option, as described in patent specification DE 199 30 526 A for example, is to render the foam structure of a polyurethane flexible foam hydrophilic. This is done by reacting at least one polyisocyanate with at least one compound containing at least two bonds which react with isocyanate in the presence of sulphonic acids containing one or more hydroxyl groups, and/or their salts and/or polyalkylene glycol ethers catalysed by monools. Such foams are used for domestic sponges or hygiene articles.

Another option is described in patent specification DE 101 16 757 A1, based on an open-pored hydrophilic aliphatic polymethane foam with an additional separate layer made from cellulose fibres with a hydrogel embedded in it, serving as a storage means.

Patent specification EP 0 793 681 B1 and the German translation of DE 695 10 953 T2 disclose a method of producing flexible foams, for which superabsorber polymers (SAPs), also known as hydrogels, are used. The SAPs which are used may be pre-mixed with the prepolymer, which makes the method very simple for the foam manufacturer. Such SAPs may be selected from SAPs grafted with starch or cellulose using acrylonitrile, acrylic acid or acrylamide as an unsaturated monomer for example. Such SAPs are sold by Höchst/Cassella under the name of SANWET IM7000.

Patent specification WO 96/31555 A2 describes a foam with a cellular structure and the foam also contains superabsorber polymers (SAPs). In this instance, the SAP may be made from a synthetic polymer or alternatively from cellulose. The foam used in this instance is intended to absorb moisture and fluids and retains them in the foam structure.

Patent specification WO 2007/135069 A1 discloses shoe soles with water-absorbing properties. In this instance, water-absorbing polymers are added prior to foaming the plastic. Such water-absorbing polymers are usually made by polymerising an aqueous monomer solution and then optionally crushing the hydrogel. The water-absorbing polymer and the dried hydrogel made from it is then preferably ground and screened once it has been produced, and the particle sizes of the screened, dried hydrogel is preferably smaller than 1000 μm and preferably bigger than 10 μm. In addition to the hydrogel, filler may also be added and mixed in before the foaming process, in which case the organic fillers which may be used include carbon black, melamine, rosin and cellulose fibres, polyamide, polyacrylonitrile, polyurethane or polyester fibres based on the principle of aromatic and/or aliphatic dicarboxylic acid esters and carbon fibres, for example. All of the substances are added to the reaction mixture separately from one another in order to produce the foam element.

In terms of their properties, foams known from the prior art are designed so that they are able to store and retain the moisture they absorb for a long period of time. The absorbed moisture and the absorbed water is not restored to the full initial state due to evaporation of the moisture to the ambient atmosphere until after a period of 24 hours, as explained in WO 2007/135069 A1.

This evaporation rate is much too slow for normal applications, such as in mattresses, shoe insoles or vehicle seats, for example, which are used for several hours a day and therefore have much less than 24 hours in order to evaporate the absorbed moisture. In this context, one might speak of an equilibrium moisture and the moisture value is that at which the foam is in equilibrium with the moisture contained in the ambient atmosphere.

Accordingly, the underlying objective of this invention is to propose a foam element, which contains a material intended to improve its moisture management in terms of the evaporation rate but is also easy to process when manufacturing the foam.

This objective is achieved by the invention on the basis of the characterising features defined in claim 1. The advantage of the characterising features defined in claim 1 resides in the fact that adding cellulose to the foam structure imparts a sufficiently high capacity to absorb moisture and fluid but the absorbed moisture or fluid evaporates in the ambient atmosphere as quickly as possible again from the state induced following use, thereby restoring the equilibrium moisture. Using cellulose-II avoids having to use a material with a fibrous structure, thereby making it easier to pour and avoiding mutual hooking of the fibres. The evaporation time depends on the intended purpose or application of the foam element and the equilibrium moisture should be restored at the latest within 16 hours after use in the case of a mattress, for example. In the case of shoe soles or shoe insoles, this time may be even shorter. For this reason, a certain proportion of cellulose is added as the hydrophilic substance, which is added and mixed at the same time as one of the components forming the foam during the foam manufacturing process. Not only does the cellulose impart a sufficient storage capacity, it also results in rapid evaporation of the absorbed moisture back to the ambient environment. Due to the proportion of cellulose added, the absorption capacity and evaporation rate of the foam element can be easily adapted to suit a range of different applications.

Independently of the above, the objective of the invention may also be achieved on the basis of the characterising features defined in claim 2. The advantage of the characterising features defined in claim 2 resides in the fact that adding cellulose to the foam structure imparts a sufficiently high capacity to absorb moisture and fluid but the absorbed moisture or fluid is evaporated in the ambient atmosphere as rapidly as possible again from the state induced by use, thereby restoring the equilibrium moisture. Due to the special combination of adding cellulose-II and the density values obtained as a result, a very high absorption of water vapour and absorption of moisture is obtained. Due to the high value of the temporary storage of moisture or water which can be absorbed in the foam element during use, the user can be guaranteed to experience a pleasant and dry feeling during use. As a result, the body does not come into direct contact with the moisture.

Independently of the above, the objective of the invention can also be achieved on the basis of the characterising features defined in claim 3. The advantage gained as a result of the characterising features defined in claim 3 resides in the fact that adding cellulose to the foam structure imparts a sufficiently high capacity to absorb moisture and fluid but the absorbed moisture or fluid is evaporated in the ambient atmosphere as rapidly as possible again from the state induced after use, thereby restoring the equilibrium moisture. Due to the special combination of adding cellulose-II and the density values obtained as a result, a very high absorption of water vapour and absorption of moisture is obtained. As a result, whilst being comfortable to use, moisture absorbed by the foam element evaporates rapidly. This being the case, even after having absorbed a high amount of moisture, it can be used again even after a relatively short period of time and a dried foam element is quickly ready for use again.

Also of advantage is another embodiment defined in claim 4, whereby depending on the resultant foam structure of the plastic foam, the fibre length can be set so as to ensure optimum moisture transport, to obtain both rapid absorption and rapid evaporation after use.

An embodiment defined in claim 5 is also of advantage because it enables an even finer distribution of the cellulose particles in the foam structure to be achieved, as a result of which the foam element can be easily adapted to suit different applications.

The embodiment defined in claim 6 enables the pouring capacity of the particles to be improved. The specific surface is increased due to the surface structure, which is irregular and not completely smooth, which contributes to an outstanding adsorption behaviour of the cellulose particles.

Another embodiment defined in claim 7 offers the possibility of using such particles without clogging the fine orifices in the nozzle plate, even when using so-called CO₂ foaming.

Also of advantage is another embodiment defined in claim 8 because a spherical shape is avoided as a result and an irregular surface without fibrous fraying and fibrils is obtained. A rod-shaped design is avoided and this is conducive to efficient distribution within the foam structure.

As a result of the embodiment defined in claim 9, the cellulose can be added and displaced during the manufacturing process at the same time as at least one other additive, which means allowance has to be made for only a single additive when mixing it in a reaction component.

Also of advantage is an embodiment defined in claim 10, because a foam element can be obtained which can be used in a range of different applications.

Based on another embodiment described in claim 11, even better transport of the moisture inside the foam element is achieved.

Using the foam element for a range of different applications is also of advantage because it improves wearing comfort during use and the subsequent drying time is also significantly faster. This is of particular advantage in the case of different types of seats and mattresses, as well all those types of applications in which moisture is exuded by the body.

### BRIEF DESCRIPTION OF THE DRAWINGS

To provide a clearer understanding, the invention will be explained in more detail below with reference to the appended drawings.

These are simplified diagrams illustrating the following:

FIG. 1 is a first graph illustrating moisture absorption between two pre-defined climates based on different samples and different sampling points;

FIG. 2 is a second graph illustrating the different moisture absorbing capacity of conventional foam and foam displaced with cellulose particles;

FIG. 3 is a third graph illustrating the different moisture evaporation rates of conventional foam and foam displaced with cellulose particles;

FIG. 4 is a bar graph illustrating the absorption of water vapour by conventional plastic foam and plastic foam displaced with cellulose particles.

### DETAILED DESCRIPTION

Firstly, it should be pointed out that the same parts described in the different embodiments are denoted by the same reference numbers and the same component names and the disclosures made throughout the description can be transposed in terms of meaning to same parts bearing the same reference numbers or same component names. Furthermore, the positions chosen for the purposes of the description, such as top, bottom, side, etc., relate to the drawing specifically being described and can be transposed in terms of meaning to a new position when another position is being described. Individual features or combinations of features from the different embodiments illustrated and described may be construed as independent inventive solutions or solutions proposed by the invention in their own right.

All the figures relating to ranges of values in the description should be construed as meaning that they include any and all part-ranges, in which case, for example, the range of 1 to 10 should be understood as including all part-ranges starting from the lower limit of 1 to the upper limit of 10, i.e. all part-ranges starting with a lower limit of 1 or more and ending with an upper limit of 10 or less, e.g. 1 to 1.7, or 3.2 to 8.1 or 5.5 to 10.

A more detailed explanation will firstly be given of the hydrophilic substance, provided in the form of cellulose, incorporated in the plastic foam, in particular in the foam element made from it. Accordingly, the foam element is made from the plastic foam as well as the hydrophilic substance incorporated in it. The plastic foam may in turn be made from an appropriate mixture of components which can be foamed with one another, preferably in liquid form, in a manner which has long been known.

As already explained above, cellulose fibres are added in addition to the water absorbing polymer as an extra filler in patent specification WO 2007/135 069 A1. These are intended to enhance the mechanical properties of the foam as necessary. In this respect, however, it has been found that adding fibrous additives makes it more difficult to process the initial mixture to be foamed because its flow behaviour changes. For example, fibrous cellulose particles mixed with the polyol component in particular prior to foaming would make it more viscous, which would make it more difficult or even totally impossible to mix with the other component, namely isocyanate, in the metering head of the foaming unit. It could also make it more difficult to spread the reaction compound through flow on the conveyor belt of the foaming unit. The fibrous cellulose particles might also have more of a tendency to adhere in the conveyor lines for the reaction mixture, forming deposits.

As a result, it is only possible to add fibrous additives within certain limits. The smaller the quantity of fibrous additives as a proportion, in particular cellulose short-cut fibres, the lower the water absorption capacity is when it is added to foam. Even adding small quantities of fibrous cellulose powder can be expected to increase viscosity, especially of the polyol component. Although it is possible to process such mixtures in principle, allowance has to be made for the altered viscosity during processing.

Cellulose and yarns, fibres or powders made from it are usually obtained by processing and grinding cellulose or alternatively wood and/or annual plants, in a generally known manner.

Depending on the nature of the production process, powders of different qualities are obtained (purity, size, etc.). What all these powders have in common is a fibrous structure because natural cellulose of any size has a marked tendency to form such fibrous structures. Even MCC (microcrystalline cellulose), which can be described as spherical, is still made up of crystalline fibre pieces.

Depending on the microstructure, a distinction is made between different structure types of cellulose, in particular cellulose-I and cellulose-II. These differences between these two structure types are described at length in the relevant reference literature and can also be seen using X-ray technology.

A major part of cellulose powders consists of cellulose-I. The production and use of cellulose-I powders is protected by a large number of patents. Also protected are many technical details of the grinding process, for example. Cellulose-I powders are of a fibrous nature, which is not very conducive to a number of applications and can even be a hindrance. For example, fibrous powders often lead to hooking of the fibres. They are also associated with a limited ability to flow freely.

Cellulose powders with a base of cellulose-II are currently very difficult to find on the market. Such cellulose powders with this structure may be obtained either from a solution (usually viscose) or by grinding cellulose-II products. Such a product might be cellophane, for example. Such fine powders with a grain size of von 10 μm and less can also be obtained in very small quantities only.

Spherical, non-fibrillar cellulose particles with a particle size in the range of between 1 μm and 400 μm can be produced from a solution of non-derivatised cellulose in a mixture or organic substance and water.

This solution is cooled free flowing to below its setting temperature and the solidified cellulose solution is then ground. The solvent is then washed out and the ground particles dried. The subsequent grinding is usually done in a mill.

It is of particular advantage if at least individual ones of the following additives are incorporated in the pre-prepared cellulose solution prior to cooling it and subsequently setting it. This additive may be selected from the group comprising pigments, inorganic substances such as titanium oxide for example, in particular below stoichiometric titanium dioxide, barium sulphate, ion exchangers, polyethylene, polypropylene, polyester, carbon black, zeolite, activated carbon, polymeric superabsorbers or flame retardants. They are then simultaneously incorporated in the cellulose particles produced subsequently. They can be added at various points whilst producing the solution but in any case prior to setting. In this respect, 1% by weight to 200% by weight of additives may be incorporated, relative to the cellulose quantity. It has been found that these additives are not removed during washing but remain in the cellulose particles and also largely retain their function. If incorporating activated carbon, for example, it will be found that its active surface, which can be measured using the BET method for example, is also preserved intact in the finished particle. Not only the additives at the surface of the cellulose particles but also those in the interior are likewise fully preserved. This may be regarded as particularly beneficial because only small quantities of additives have to be incorporated in the pre-prepared cellulose solution.

The advantage of this is that it is only the cellulose particles already containing the functional additives which have to be added to the reaction mixture for producing the foam element. Whereas in the past all the additives have been added separately and individually to the reaction mixture, it is now only necessary to take account of one type of additive when setting up the foaming process. This avoids any uncontrollable fluctuations with regard to the suitability of many of these different additives.

As a result of this approach, only one cellulose powder is obtained, which is made up of particles with a cellulose-II structure. The cellulose powder has a particle size in a range with a lower limit of 1 μm and an upper limit of 400 μm for a mean particle size×50 with a lower limit of 4 μm and an upper limit of 250 μm for a monomodal particle size distribution. The cellulose powder or the particles have an approximately spherical particle shape with an irregular surface and a crystallinity in a range with a lower limit of 15% and an upper limit of 45% based on the Raman method. The particles also have a specific surface (N2-Adsorbtion, BET) with a lower limit of 0.2 m²/g and an upper limit of 8 m²/g for a bulk density with a lower limit of 250 g/l and an upper limit of 750 g/l auf.

The cellulose-II structure is produced by dissolving and re-precipitating the cellulose, and the particles are different in particular from the particles made from cellulose without a dissolution step.

The particle size in the above-mentioned range with a lower limit of 1 μm and an upper limit of 400 μm with a particle distribution characterised by a ×50 value with a lower limit of 4 μm, in particular 50 μm, and an upper limit of 250 μm, in particular 100 μm, is naturally affected by the operating mode used for grinding during the milling process. However, this particle distribution can be obtained particularly easily by adopting the specific production method based on setting a free flowing cellulose solution and due to the mechanical properties imparted to the set cellulose compound. Applying shearing forces to a set cellulose solution under the same grinding conditions would result in different but fibrillous properties.

The shape of the particles used is approximately spherical. These particles have an axial ratio (l:d) within a lower limit of 1 and an upper limit of 2.5 f. They have an irregular surface but do not show up any fibre-like fraying or fibrils under the microscope. These are absolutely not spheres with a smooth surface. Nor would such a shape be particularly suitable for the intended applications.

The bulk density of the cellulose powders described here, which lies between a lower limit of 250 g/l and an upper limit of 750 g/l, is significantly higher than comparable fibrillar particles known from the prior art. The bulk density has significant advantages in terms of processing because it also improves the compactness of the described cellulose powder and amongst other things also results in better flow capacity, miscibility in a range of different media and fewer problems during storage.

In summary, it may be said that the resultant particles of cellulose powder are able to flow more freely due to their spherical structure and induce hardly any changes in viscosity due to their structure. Characterising the particles by means of the particle sizing equipment widely used in the industry is also easier and more meaningful due to the spherical shape. The not completely smooth and irregular surface structure results in a bigger specific surface, which contributes to the outstanding adsorption behaviour of the powder.

Independently of the above, however, it would also be possible to mix a pure cellulose powder or particles of it with other cellulose particles, which also contain incorporated additives within a lower limit of 1% by weight and an upper limit of 200% by weight by reference to the quantity of cellulose. Individual ones of these additives may also be selected from the group comprising pigments, inorganic substances such as titanium oxide for example, in particular below stoichiometric titanium dioxide, barium sulphate, ion exchangers, polyethylene, polypropylene, polyester, activated carbon, polymeric superabsorbers and flame retardants.

Depending on the foaming method used to produce the foams, the spherical cellulose particles have proved to be particularly practical compared with the known fibrous cellulose particles, especially in the case of CO₂ foaming. CO₂ foaming may be run using the Novaflex-Cardio method or similar processes, for example, in which nozzle plates with particularly fine orifices are used.

Coarse and fibrous particles would immediately block the nozzle orifices and lead to other problems. For this reason, the high degree of fineness of the spherical cellulose particles is of particular advantage for this specific foaming process.

The foam element and the approach to producing the foam element proposed by the invention will now be explained in more detail with reference to a number of examples. These should be construed as possible embodiments of the invention but the invention is in no way limited to the scope of these examples.

The figures relating to moisture as a % by weight relate to the mass or weight of the foam element as a whole (plastic foam, cellulose particles and water or moisture).

### Example 1

The foam element to be produced may be made from a plastic foam such as a polyurethane flexible foam for example, and a whole range of different manufacturing options and methods may be used. Such foams usually have an open-cell foam structure. This can be obtained using a “QFM” foaming machine made by the Hennecke company, and the foam is produced in a continuous process by a high-pressure metering process. All the necessary components are exactly metered under the control of a computer via controlled pumps and mixed using the stirring principle. In this particular case, one of these components is polyol, which is displaced with the cellulose particles described above. Since the cellulose particles are mixed with one reaction component, polyol, various adjustments have to be made to the formula, such as the water, catalysts, stabilisers and TDI in order to largely neutralise the effect of the cellulose powder incorporated for production purposes and the subsequent physical values obtained.

One possible foam based on the invention was produced with 7.5% by weight of spherical cellulose particles. To this end, a spherical cellulose powder was firstly produced, which was then added to a reaction component of the foam to be produced. In terms of quantity, the proportion of cellulose by reference to the total weight of the foam, in particular the plastic foam may be within a lower limit of 0.1% by weight, in particular 5% by weight, and an upper limit of 10% by weight, in particular 8.5% by weight.

### Example 2

### Comparative Example

To permit a comparison with example 1, a foam element was made from a plastic foam, which was produced without adding cellulose powder or cellulose particles. This might be standard foam, an HR-foam or a viscose foam, each made up by a known formula and then foamed.

The first objective was to ascertain whether the cellulose particles were uniformly distributed through all layers of the resultant foam element in terms of height. This was done by determining a so-called equilibrium moisture based on the water uptake of the foams in a standard climate at 20° C. and 55% r.h. and in another standardised climate at 23° C. and 93% r.h. To this end, sample pieces of the same size were taken from the foam blocks made as specified in example 1 and example 2 at three different heights and the water uptake in the two standardised climates described above was measured. In this respect, 1.0 m represents the top layer of the foam block, 0.5 m the middle layer and 0.0 m the bottom layer of the foam from which the sample pieces were taken from the plastic foam displaced with cellulose particles. The total height of the block was ca. 1 m. The cellulose-free plastic foam from example 2 was used to make a comparison.

TABLE 1

Sample

| | Ex. 1 | Ex. 1 | Ex. 1 | |
|---|---|---|---|---|
| | Top | Middle | Bottom | Ex. 2 |
| Standardised | 1.6% | 1.6% | 1.5% | 0.7% |
| climate | | | | |
| Physical | 4.6% | 4.7% | 4.5% | 2.5% |
| equilibrium | | | | |
| moisture | | | | |

As may be seen from these figures, the foam displaced with cellulose particles absorbs significantly more moisture than the cellulose-free foam, both in the standard climate and in the other standardised climate with the physical equilibrium moisture. There is also a relatively good match for the measurement results in terms of the different points from which the sample pieces were taken (top, middle, bottom), enabling one to conclude that there was a homogeneous distribution of the cellulose particles in the foam element produced.

Table 2 below sets out the mechanical properties of the two foams made as specified in example 1 and example 2. It is clearly evident that the foam type made with cellulose particles has comparable mechanical properties to the foam that was not displaced with cellulose particles. This indicates problem-free processing of the reaction components, especially if they incorporate the spherical cellulose particles.

TABLE 2

| | Foam type | | | | | | | |
|---|---|---|---|---|---|---|---|---|
| | A | | A | | B | | B | |
| Proportion of | 0% | | 10% | | 0% | | 7.50% | |
| powder (cellulose | | | | | | | | |
| particles) | | | | | | | | |
| Density | 33.0 | kg/m³ | 33.3 | kg/m³ | 38.5 | kg/m³ | 43.8 | kg/m³ |
| Compression | 3.5 | kPa | 2.3 | kPa | 2.7 | KPa | 3.0 | kPa |
| hardness 40% | | | | | | | | |
| Elasticity | 48% | | 36% | | 55% | | 50% | |
| Tear resistance | 140 | Kpa | 100 | kPa | 115 | KPa | 106 | kPa |

| | | | | |
|---|---|---|---|---|
| Expansion | 190% | 160% | 220% | 190% |
| Wet compression set | 6% | 50% | 6% | 9% |
| (22 h./70% | | | | |
| Comp./50° C./95% r.h.) | | | | |

The foam with no added cellulose particles should have the following desired values for both specified foam types:

| Foam type | | |
|---|---|---|
| | A | B |

| Density | 33.0 | kg/m³ | 38.5 | kg/m³ |
|---|---|---|---|---|
| Compression | 3.4 | kPa | 2.7 | kPa |
| hardness 40% | | | | |
| Elasticity | >44% | | >45% | |
| Tear resistance | >100 | kPa | >100 | kPa |

| | | |
|---|---|---|
| Expansion | >150% | >150% |
| Wet compression set | <15% | <15% |
| (22 h./70% | | |
| Comp./50° C./95% r.h.) | | |

The average weight by volume or density of the foam element as a whole is within a range with a lower limit of 30 kg/m³ and an upper limit of 45 kg/m³.

FIG. 1 gives the foam moisture as a percentage for sample bodies of the same type but taken from different points of the total foam element, as described above. The foam moisture as a [%] is plotted on the ordinate. The proportion of added cellulose powder or cellulose particles in this example is 10% by weight and the cellulose particles are the spherical cellulose particles described above. These different individual samples with and without additive are plotted on the abscissa.

The measurement points for the foam moisture of the individual samples shown as circles represent the initial value and the measurements shown as squares are for the same sample but after one day of moisture uptake. The lower initial values were determined for the standard climate described above and the other value shown for the same sample represents moisture uptake in the other standardised climate after 24 hours at 23° C. and 93% r.h. The abbreviation r.h. stands for relative humidity or air humidity and is given as a %.

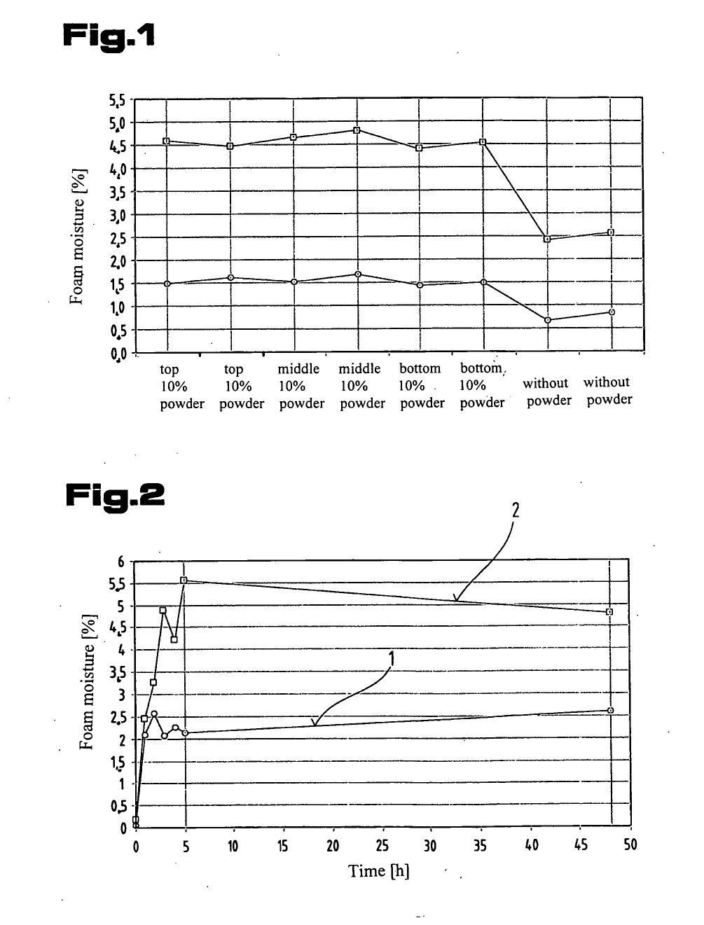

FIG. 2 plots moisture uptake over a period of 48 hours, the values for time (t) being plotted on the abscissa in [h]. The initial state of the sample body is again that of the standard climate of 20° C. and 55% r.h defined above. The other standardised climate at 23° C. and 93% r.h. is intended to represent a climate based on use or body climate to enable the period during which the foam moisture increased as a % by weight to be determined. The values for foam moisture are plotted on the ordinate as a [%].

A first graph line 1 with measurement points shown as circles represents a foam element with a pre-defined sample size based on example 2 with no added cellulose particles or cellulose powder.

Another graph line 2 with measurement points shown as squares represents the foam moisture of a foam element to which 7.5% by weight of cellulose particles or cellulose powder were added. The cellulose particles are again the spherical cellulose particles described above.

The graph plotting the moisture uptake over 48 hours shows that the physical equilibrium moisture of “the foams” in the “body climate” is reached after only a short time. From this, it can be assumed that the foam displaced with cellulose particles is able to absorb two times more moisture in 3 hours than a foam based on example 2 with no added cellulose particles.

The measurement values for the moisture uptake were obtained by storing the foam pieces with a volume of ca. 10 cm³ in a dessicator with a set air humidity (using saturated KNOB solution and 93% r.h.), having previously dried the samples. The samples were removed from the dessicator after defined times and the weight increase (=water uptake) measured. The fluctuations in the moisture uptake can be explained by the handling of the samples and a slight lack of homogeneity in the samples.

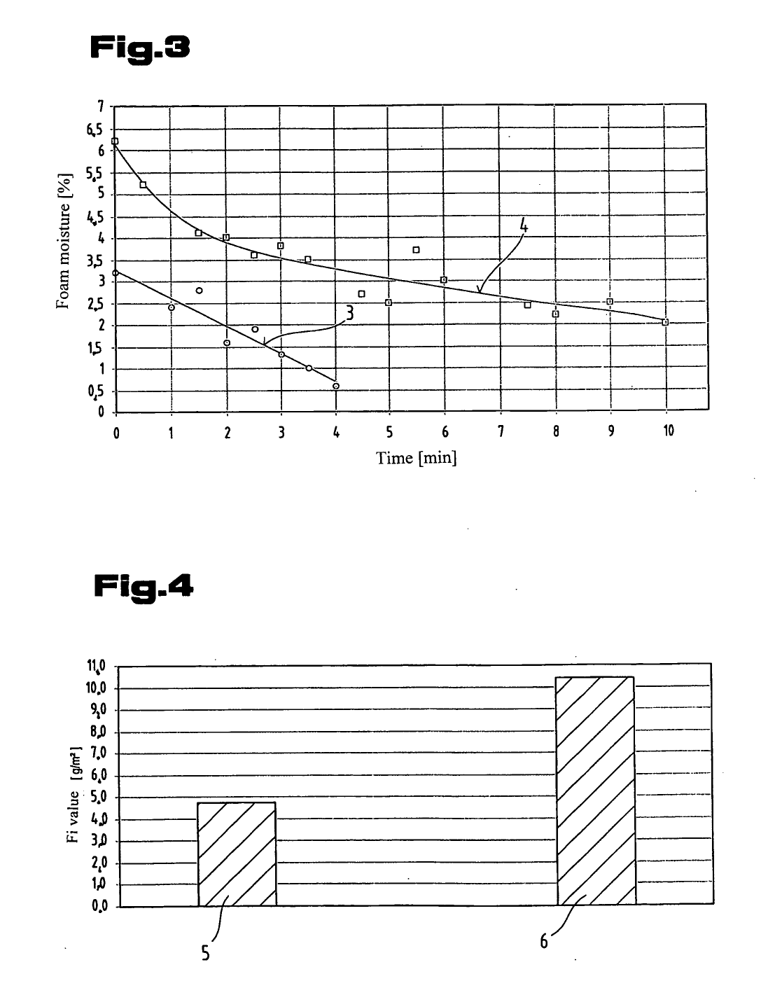

FIG. 3 illustrates the drying behaviour of a foam element with added cellulose particles based on example 1 compared with a foam based on example 2 with no such cellulose particles. For comparison purposes, the two sample pieces were firstly conditioned in the “body climate” for 24 hours. This was again at 23° C. with a relative humidity of 93%. The values for foam moisture are plotted on the ordinate as a [%] and the time (t) in [min] is plotted on the abscissa. The specified % values for foam moisture are percentages by weight relative to the mass or weight of the total foam elements (plastic foam, cellulose particles and water or moisture).

The measurement points shown as circles again relate to the foam element based on example 2 with no added cellulose particles plotting a corresponding graph line 3 representing the decrease in moisture. The measurement points shown as squares were determined for the foam element with added cellulose particles. Another corresponding graph line 4 likewise shows evidence of a rapid evaporation of the moisture. The proportion of cellulose particles was again 7.5% by weight.

It is clear that the equilibrium moisture of 2% is already restored after ca. 10 minutes. This is considerably faster than is the case with a foam known from the prior art which requires several hours for a comparable quantity of water to evaporate.

When the foam element displaced with the cellulose particles based on the crystal modification of cellulose-II was conditioned in the “body climate” for a period of 24 hours and then exposed to the “standard climate”, it initially absorbed a moisture content of more than 5% by weight and the moisture content was reduced by at least (2) % within a period of 2 min after being introduced into the “standard climate”.

FIG. 4 is a bar graph plotting the absorption of water vapour “Fi” based on Hohenstein in [g/m²] and these values are plotted on the ordinate.

The period during which the water vapour was absorbed from the standard climate of 20° C. and 55% r.h. defined above and in the standardised climate of 23° C. and 93% r.h. also defined above (application climate and body climate) for the two measurement values obtained was 3 (three) hours. The sample bodies were of foam type “B” described above. A first graph bar 5 plots foam type “B” without added cellulose or cellulose particles. The measured value in this case was approximately 4.8 g/m². The foam body displaced with cellulose, on the other hand, showed a higher value of ca. 10.4 g/m² and this is plotted on another graph bar 6. This other value is therefore higher than a value of 5 g/m² based on Hohenstein.

The foam element is made from a plastic foam, and a PU foam was used as the preferred foam. As explained above in connection with the individual diagrams, the moisture uptake was determined starting from a so-called equilibrium moisture representing a “standard climate” at 20° C. with a relative humidity of 55%. In order to simulate usage, another standardised climate was defined at 23° C. with a relative humidity of 93%. This other standardised climate is intended to represent the moisture absorbed during use due to a body of a living being exuding sweat, for example a person. The cellulose incorporated in the foam element is intended to disperse moisture absorbed during use over a period within a range with a lower limit of 1 hour and an upper limit of 16 hours again after use and thus restore the entire foam element to the equilibrium moisture by reference to the ambient atmosphere. This means that the stored moisture evaporates from the cellulose very rapidly after use, being emitted to the ambient atmosphere and thus drying the foam element.

As mentioned above, an equilibrium moisture can be said to exist when the foam element has been exposed to one of the ambient atmospheres described above to the degree that the moisture value of the foam element (foam moisture) is in equilibrium with the value of the moisture contained in the ambient atmosphere. On reaching the equilibrium moisture level, there is no longer any exchange of moisture between the foam element and the ambient atmosphere around the foam element

The test methods described above can be run in such a way that the foam element is exposed to the first ambient atmosphere with the first climate based on the predefined temperature and relative air humidity, for example 20° C. and 55% r.h. until the equilibrium moisture is reached in this ambient atmosphere, after which the same foam element is exposed to a second, changed or different ambient atmosphere which is different from the first ambient atmosphere. This second ambient atmosphere has a second climate with a higher temperature and/or higher relative air humidity than the first climate, for example 23° C. and 93% r.h. As a result, the value of the foam moisture increases and the moisture is absorbed by the cellulose incorporated in the foam. The same foam element is then exposed to the first ambient atmosphere again, and after the period of between 1 hour and 16 hours specified above, the initial value of the foam moisture corresponding to the equilibrium moisture based on the first ambient atmosphere is restored. Within this period, therefore, the moisture absorbed by the cellulose from the second ambient atmosphere is evaporated to the ambient atmosphere and reduced as a result.

The lower value of 1 hour specified here will depend on the quantity of liquid or moisture absorbed but may also be significantly lower, in which case it may be just a few minutes.

Independently of the spherical cellulose particles described above, it is also possible to use cellulose in the form of cut fibres with a fibre length of within a lower limit of 0.1 mm and an upper limit of 5 mm. However, it would likewise be possible to use cellulose in the form of ground fibres with a particle size within a lower limit of 50 μm and an upper limit of 0.5 mm.

Depending on the application, the foam to be produced will have different foam properties and these are characterised by a range of different physical properties.

The compression hardness at 40% compression may be within a lower limit of 1.0 kPa and an upper limit of 10.0 kPa. The elasticity as measured by the ball drop test may have a value with a lower limit of 5% and an upper limit of 70%. This test method is carried out in accordance with standard EN ISO 8307 and the rebound height and associated reverse parallel elasticity are determined.

If the foam element produced is made from a polyurethane foam, in particular a flexible foam, it may be produced with both a base of TDI and a base of MDI. However, it would also be possible to use other foams, such as polyethylene foam, polystyrene foam, polycarbonate foam, PVC foam, polyimide foam, silicone foam, PMMA (polymethyl methacrylate) foam, rubber foam, for example. The high moisture uptake will then depend on the raw material system and the method used to produce the foam because the reversible capacity to absorb moisture is obtained by incorporating or embedding the cellulose. It is preferable to use foams of the type with open pores, which permit an unhindered exchange of air with the ambient atmosphere. It is also essential to ensure that the cellulose added to the foam structure is homogeneously distributed, as described above in connection with the tests that were conducted. If the foam does not have an open structure, it can be specifically treated by known methods to obtain open pores.

If polyol is used as an initial material for one of the reaction components, the cellulose can be added to it prior to foaming. The cellulose may be added by stirring it in or dispersing it using methods known in the industry. The polyol used is the one needed for the corresponding foam type and is added in the requisite quantity specified in the formula. However, the moisture content of the cellulose particles must be taken into account when setting up the formula.

The foam element may be used to make individual plastic products and the plastic products may be selected from the group comprising mattresses, furniture upholstery and pillows.

The embodiments illustrated as examples represent possible variants of the foam element with a hydrophilic substance in the form of cellulose incorporated in the plastic foam, and it should be pointed out at this stage that the invention is not specifically limited to the variants specifically illustrated, and instead the individual variants may be used in different combinations with one another and these possible variations lie within the reach of the person skilled in this technical field given the disclosed technical teaching. Accordingly, all conceivable variants which can be obtained by combining individual details of the variants described and illustrated are possible and fall within the scope of the invention.

The objective underlying the independent inventive solutions may be found in the description.

### LIST OF REFERENCE NUMBERS

1 Graph line
2 Graph line
3 Graph line
4 Graph line
5 Graph bar
6 Graph bar

1. Foam element with a hydrophilic substance in the form of cellulose incorporated in the foam, and the foam element displaced with the cellulose has a reversible capacity to absorb moisture, wherein the cellulose is provided in the form of a structure type based on the crystal modification of cellulose-II, and a proportion of cellulose by reference to the total weight of the foam is selected from a range with a lower limit of 0.1% by weight, in particular 5% by weight, and an upper limit of 10% by weight, in particular 8.5% by weight, and a value of a foam moisture of the foam element is increased from an initial value of the foam moisture corresponding to an equilibrium moisture by reference to a first ambient atmosphere with a first climate based on a predefined temperature and relative air humidity during use to a value of the foam moisture by reference to a second ambient atmosphere different from the first ambient atmosphere with a second climate based on a temperature and/or a relative air humidity that is higher than that of the first climate, and the moisture absorbed by the cellulose II incorporated in the foam element after use in the second ambient atmosphere is evaporated after a period in the first ambient atmosphere with a duration within a range with a lower limit of 1 hour and an upper limit of 16 hours until the initial value of the foam moisture corresponding to the equilibrium moisture by reference to the first ambient atmosphere is restored again.

2. Foam element with a hydrophilic substance in the form of cellulose incorporated in the foam, and the foam element displaced with cellulose has a reversible capacity to absorb moisture, in particular as claimed in claim 1, wherein the cellulose is provided in the form of a structure type based on the crystal modification of cellulose-II, and a proportion of cellulose by reference to the total weight of the foam is selected from a range with a lower limit of 0.1% by weight, in particular 5% by weight, and an upper limit of 10%, in particular 8.5% by weight, and the foam element has a density within a lower limit of 30 kg/m³ and an upper limit of 45 kg/m³, and the uptake of water vapor based on Hohenstein has an Fi value of more than 5 g/m².

3. Foam element with a hydrophilic substance in the form of cellulose incorporated in the foam, and the foam element displaced with the cellulose has a reversible capacity to absorb moisture, in particular as claimed in claim 1, wherein the cellulose is provided in the form of a structure type based on the crystal modification of cellulose-II, and a proportion of cellulose by reference to the total weight of the foam is selected from a range with a lower limit of 0.1% by weight, in particular 5% and an upper limit of 10%, in particular 8.5% by weight, and the foam element has a density with a lower limit of 30 kg/m³ and an upper limit of 45 kg/m³, and a value of initially more than 5% of the foam moisture of the foam element from the second ambient atmosphere with the second climate is reduced by at least 2% due to the effect of the first ambient atmosphere with the first climate based on 20° C. and a relative humidity of 55% within a period of 2 min.

4. Foam element as claimed in claim 1, wherein the cellulose-II is provided in the form of cut fibers with a fiber length with a lower limit of 0.1 mm and an upper limit of 5 mm.

5. Foam element as claimed in claim 1, wherein the cellulose-II is provided in the form of ground fibers with a particle size with a lower limit of 50 μm and an upper limit of 0.5 mm.

6. Foam element as claimed in claim 1, wherein the cellulose-II is provided in the form of spherical cellulose particles.

7. Foam element as claimed in claim 6, wherein the spherical cellulose particles have a particle size with a lower limit of 1 μm and an upper limit of 400 μm.

8. Foam element as claimed in claim 6, wherein the spherical cellulose particles have an axial ratio (l:d) within a lower limit of 1 and an upper limit of 2.5.

9. Foam element as claimed in claim 1, wherein the cellulose contains at least one of the additives from the group comprising pigments, inorganic substances such as titanium oxide, below stoichiometric titanium oxide, barium sulphate, ion exchangers, polyethylene, polypropylene, polyester, carbon black, zeolite, activated carbon, polymeric superabsorbers or flame retardants.

10. Foam element as claimed in claim 1, wherein the foam is selected from the group comprising polyurethane foam (PU foam), polyethylene foam, polystyrene foam, polycarbonate foam, PVC foam, polyimide foam, silicone foam, PMMA (polymethyl methacrylate) foam, rubber foam.

11. Foam element as claimed in claim 1, wherein the foam has an open cell foam structure.

12. Use of a foam element as claimed in claim 1 to make a plastic product, and the plastic product is selected from the group comprising mattresses, furniture upholstery, pillows.
